(19) United States
(12) Patent Application Publication
(10) Pub. No.: US 2024/0146192 A1
(43) Pub. Date: May 2, 2024

(54) VOLTAGE CONVERTER AND CONTROLLER FOR SAME

(71) Applicant: Lear Corporation, Southfield, MI (US)

(72) Inventors: Hector SARNAGO ANDIA, Olvega (Soria) (ES); Oscar LUCIA GIL, Zaragoza (ES); Ruben MOLINA LLORENTE, Reus (ES); Antonio MARTINEZ PEREZ, Tarragona (ES); Pablo GAONA ROSANES, Sarreal (ES); Rafael JIMENEZ PINO, Valls (ES)

(73) Assignee: Lear Corporation, Southfield, MI (US)

(21) Appl. No.: 18/477,734

(22) Filed: Sep. 29, 2023

Related U.S. Application Data
(60) Provisional application No. 63/381,622, filed on Oct. 31, 2022.

(51) Int. Cl. H02M 3/158; H02M 3/07

(52) U.S. Cl. CPC H02M 3/158; H02M 3/07

(57) ABSTRACT

A voltage converter includes a converter stage having a direct current to direct current (DC-to-DC) voltage converter, wherein the converter stage receives a first DC voltage and outputs a second DC voltage different than the first DC voltage. The voltage converter also includes a boost pre-stage having a boosting circuit and a capacitor, wherein the boost pre-stage receives a DC voltage from a battery and outputs a boosted DC voltage to the converter stage as the first voltage, wherein the boosted DC voltage is greater than the DC voltage from the battery. The boosted DC voltage of the boost pre-stage output to the converter stage provides fault resistant operation of the converter stage in the event of one or more fluctuations in an operating range of the DC voltage from the battery.

### CROSS-REFERENCE TO RELATED APPLICATION

This application claims the benefit of U.S. Provisional Application Ser. No. 63/381,622 filed on Oct. 31, 2022, the disclosure of which is hereby incorporated by reference herein in its entirety.

### TECHNICAL FIELD

The present disclosure relates to a direct-current-to-direct-current (DC-to-DC) voltage converter and a controller for the same.

### BRIEF DESCRIPTION OF THE DRAWINGS

FIG. 1 is a simplified block diagram of a non-limiting, exemplary embodiment of a high-voltage (HV) to low voltage (LV) DC-to-DC voltage converter;

FIG. 2 is a simplified block diagram of a non-limiting, exemplary embodiment of another high-voltage (HV) to low voltage (LV) DC-to-DC voltage converter;

FIG. 3 is a simplified block diagram of a non-limiting, exemplary embodiment of a high-voltage (HV) to low voltage (LV) DC-to-DC voltage converter according to the present disclosure; and

FIG. 4 is a simplified block diagram of a non-limiting, exemplary embodiment of another high-voltage (HV) to low voltage (LV) DC-to-DC voltage converter according to the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, features, and elements have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

“One or more” and/or “at least one” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

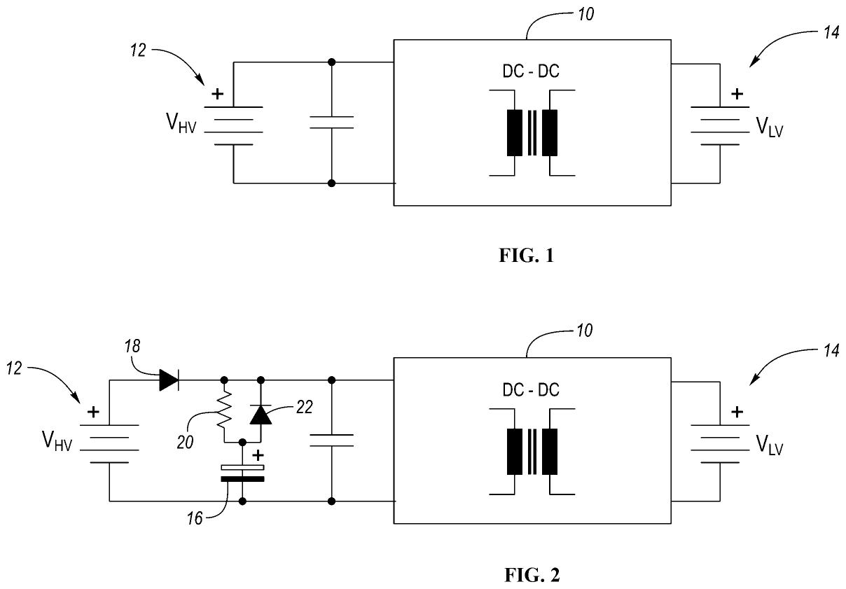

FIG. 1 is a simplified block diagram of a non-limiting, exemplary embodiment of a high-voltage (HV) to low voltage (LV) DC-to-DC voltage converter 10. FIG. 2 is a simplified block diagram of a non-limiting, exemplary embodiment of another high-voltage (HV) to low voltage (LV) DC-to-DC voltage converter 10.

The DC-to-DC converter 10 may be configured to convert a high-voltage level provided by a HV battery 12 to a low-voltage level in order to power a low-voltage electrical network, including low-voltage electrical loads in an electric vehicle (not shown), and to charge a LV battery 14 that also provides low-voltage electrical power to such a low-voltage electrical network. In an exemplary embodiment, the voltage of the HV battery 12 may be greater than or equal to 48 volts, while the voltage of the LV battery 14 may be less than or equal to 24 volts, although HV and LV batteries with other voltage levels may be utilized.

Thus, the HV to LV (HV/LV) DC-to-DC voltage converter 10 shown in FIGS. 1 and 2 is designed for providing electrical energy or power to a LV powernet or electrical network from the HV battery 12. The LV electrical loads (not shown) are supported by the DC-to-DC converter 10 and the battery system, including the LV battery 14, in parallel. As previously noted, the DC-to-DC converter 10 also provides for charging of the LV battery 14. It is also noted that the DC-to-DC converter 10 may optionally be configured for bi-directionality.

The DC-to-DC converter 10 should also be designed to ensure operation in the event of a malfunction of the HV powernet. While having an extremely rare occurrence rate, one example of such a malfunction is the voltage level of the HV battery 12 falling below a satisfactory threshold value, e.g., 70 volts, for proper operation of the DC-to-DC converter 10. As seen in FIG. 2, one solution to address such a malfunction is to add a capacitor 16 as an energy storage means. In that regard, when the HV battery 12 is functioning properly, diode 18 allows current to flow from the HV battery 12 to the DC-to-DC converter 10. The input voltage provided to the DC-to-DC converter 10 by the HV battery 12 is thus adequate, and the capacitor 16 is also charged through the diode 18 and a resistor 20 to approximately the voltage level of the HV battery 12. In that regard, the capacitor 16 is provided with a capacitance value (e.g., measured in farads (F)) sufficient to be charged to the desired energy level. More particularly, in an exemplary implementation or embodiment, the capacitor 16 may be configured to support a transient “glitch” at the HV input of 3 milliseconds (ms), withstanding an output power of 2.7 kilowatts (kW) during such time. As a result, in such an implementation or embodiment, the capacitor 16 may be provided with a value of 1.04 millifarads (mF) (i.e., 2.7 kW×3 msec=8.1 Joules (J); C=2×8.1/(195²−150²)=1.04 mF), which may be achieved with two (2×) 510 microfarad (μF)/450 volt (V) in parallel. In such an implementation or embodiment, resistor 20 affects only the time for a first charge, and its purpose is to limit current and avoid the input fuse blowing, such that it may be provided with a value of 100 kilo-ohms (kΩ).

However, in the event that the HV battery 12 malfunctions in the manner previously described, i.e., outputting a voltage below a satisfactory threshold value (e.g., 70 volts), the capacitor 16 then discharges through the diode 22 to thereby provide an adequate input voltage to the DC-to-DC converter 10 for proper operation thereof. In such an event, the diode 18 prevents energy discharging from the capacitor 16 from flowing back to the HV battery 12.

As previously noted, the malfunction described wherein the voltage of the HV battery 12 falls below a satisfactory threshold value (e.g., 70 volts) has an extremely rare occurrence rate. As a result, the drawback of the solution described utilizing the capacitor 16 is that the diode 18 connected in series with the HV battery 12 penalizes the overall efficiency of the HV/LV conversion provided by the DC-to-DC converter 10 for the entire life of the electric vehicle (not shown) in which the DC-to-DC converter 10 is utilized. Moreover, such an efficiency penalty is incurred to prevent a very seldom-occurring failure.

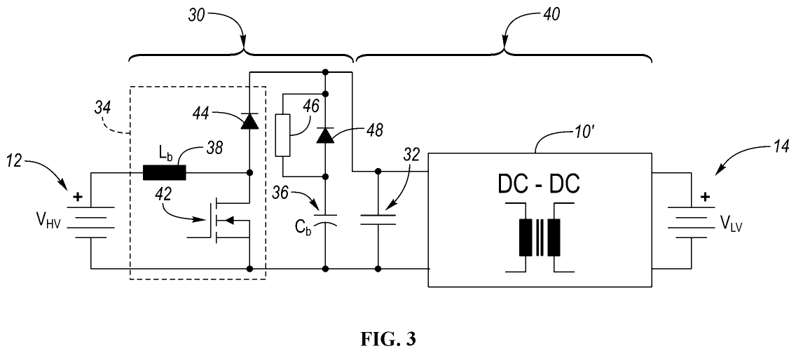

FIG. 3 is a simplified block diagram of a non-limiting, exemplary embodiment of a high-voltage (HV) to low voltage (LV) DC-to-DC voltage converter 10′ according to the present disclosure. As seen therein, to address the malfunction described previously wherein the voltage of the HV battery 12 falls below a satisfactory threshold value (e.g., 70 volts) without incurring the efficiency penalty noted to prevent a very seldom-occurring failure, a voltage boost pre-stage 30 is added before the DC-to-DC converter 10′, which together with a DC link capacitor 32 may be referred to as a converter topology or converter stage 40, to efficiently manage a wider operation input range for the DC-to-DC converter 10′.

In that regard, the boost pre-stage 30 comprises a boosting circuit 34 in combination with a high-voltage capacitor 36. The boost pre-stage 30 is cascaded with the converter stage 40, including the DC-to-DC converter 10′. The boosting circuit 34 comprises an inductor 38, a switch 42 (e.g., a transistor), and a diode 44. Closure of the switch 42 produces a magnetic field at the inductor 38, thereby storing energy. Subsequent opening of the switch 42 causes the HV battery 12 and the inductor 38 to produce a boosted voltage output level greater than the output voltage level of the HV battery 12 alone, which boosted voltage is provided as an input to the converter stage 40 and charges the HV capacitor 36 through a resistor 46 to the boosted voltage level. The value of the boosted voltage supplied by the HV battery 12 and the inductor 38 depends upon the impedance value (e.g., measured in Henries (SI)) of the inductor 38 and the operational duty cycle (i.e., ON/OFF) of the switch 42, as controlled via control signals generated by and transmitted from a control unit or controller (not shown). The impedance value of the inductor 38 and the duty cycle of the switch 42 may therefore be selected to provide the voltage increase desired for addition to the voltage level provided by the HV battery 12. In addition, the HV capacitor 36 is provided with a capacitance value (e.g., measured in farads (F)) sufficient to be charged to the desired energy level.

In the event of the malfunction described previously wherein the voltage of the HV battery 12 falls below a satisfactory threshold value (e.g., 70 volts, which may be determined for example from output provided by a sensor (not shown)), the HV capacitor 36 discharges through the diode 48 to ensure that a suitable voltage (i.e., the boosted voltage level) is provided as an input to the converter stage 40, including the DC-to-DC converter 10′. In such an event, the diode 44 prevents energy discharging from the HV capacitor 36 from flowing back to the inductor 38 and the HV battery 12.

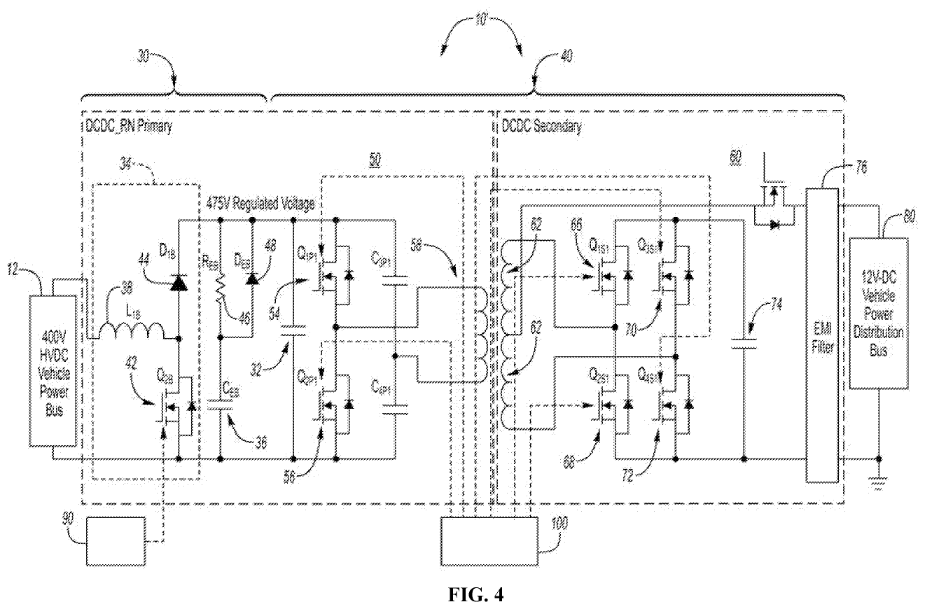

FIG. 4 is a simplified block diagram of a non-limiting, exemplary embodiment of another high-voltage (HV) to low voltage (LV) DC-to-DC voltage converter 10′ according to the present disclosure. While a simplified block diagram, FIG. 4 represents a more detailed version of FIG. 3 in regard to the converter stage 40.

As seen in FIG. 4, to once again address the malfunction described previously wherein the voltage of the 400 volt HV battery 12 falls below a satisfactory threshold value (e.g., 70) volts without incurring the efficiency penalty noted to prevent a very seldom-occurring failure, the voltage boost pre-stage 30 is added before the DC-to-DC converter 10′, which together with the DC link capacitor 32 may be referred to as the converter topology or converter stage 40, to efficiently manage a wider operation input range for the DC-to-DC converter 10′.

As previously noted, FIG. 4 shows a more detailed version of the converter stage 40 of FIG. 3. As seen in FIG. 4, the converter stage 40 spans a primary side 50 and a secondary side 60 of the DC-to-DC voltage converter 10′. In addition to the DC link capacitor 32, the primary side 50 of the DC-to-DC voltage converter 10′ includes switches 54, 56 (e.g., transistors) and a primary side transformer 58. The secondary side 60 of the DC-to-DC voltage converter 10′ includes a secondary side transformer 62 and switches 66, 68, 70, 72 (e.g., transistors), as well as a DC link capacitor 74 and an electromagnetic interference (EMI) filter 76. As previously described, in operation, the 400 volts supplied by the HV battery 12 via a HV vehicle bus is converted by the DC-to-DC voltage converter 10′ to 12 volts DC in order to supply an electrical power distribution bus 80 of an electric vehicle (not shown). The switches 54, 56 of the primary side 50 and the switches 66, 68, 70, 72 of the secondary side 60 of the DC-to-DC converter 10′ are controlled by a control unit or controller 100, which is appropriately programmed to control the switches 54, 56, 66, 68, 70, 72 to produce the HV/LV DC-to-DC voltage conversion described herein (e.g., 400 volts DC to 12 volts DC) via control signals generated by and transmitted from the controller 100. It should also be noted that the converter topology 40 shown in FIG. 4 is exemplary only, and the present disclosure may be utilized with other converter topologies. In that regard, an exemplary converter topology is disclosed in U.S. Patent Application Publication No. 2022/0060119 A1 entitled “DC-to-DC Converter,” which is hereby incorporated by reference herein in its entirety. 10025| In that regard, referring still to FIG. 4, the boost pre-stage 30 comprises the boosting circuit 34 in combination with the high-voltage capacitor 36. The boost pre-stage 30 is cascaded with the converter stage 40, including the DC-to-DC converter 10′. The boosting circuit 34 comprises the inductor 38, the switch 42, and the diode 44. Closure of the switch 42 produces a magnetic field at the inductor 38, thereby storing energy. Subsequent opening of the switch 42 causes the HV battery 12 and the inductor 38 to output a boosted voltage output level greater than the 400 volts provided by the HV battery 12, which boosted voltage is provided as an input to the converter stage 40 and charges the HV capacitor 36 through the resistor 46 to the boosted voltage level. The value of the boosted voltage supplied by the HV battery 12 and the inductor 38 depends upon the impedance value of the inductor 38 and the operational duty cycle (i.e., ON/OFF) of the switch 42, as controlled via control signals generated by and transmitted from a control unit or controller 90. As shown in FIG. 4, the value of the boosted voltage is 475 volts. In addition, the HV capacitor 36 is provided with a capacitance value (e.g., measured in farads (F)) sufficient to be charged to the desired energy level.

In the event of the malfunction described previously wherein the voltage of the HV battery 12 falls below a satisfactory threshold value (e.g., 70 volts, which may be determined for example from output provided by a sensor (not shown)), the HV capacitor 36 discharges through the diode 48 to ensure that a suitable voltage (i.e., the boosted voltage level) is provided as an input to the converter stage 40, including the DC-to-DC converter 10′. In such an event, the diode 44 prevents energy discharging from the HV capacitor 36 from flowing back to the inductor 38 and the HV battery 12.

It is noted that, in one exemplary implementation or embodiment according to the present disclosure, the inductor 38 may be provided with a value in the range of 150 microhenries (μH) for an input maximum current of 25 amps (A). As well, capacitor 36 may be provided with a value of 240 μF/500V, resistor 46 may be provided with a value of 100 kΩ, capacitor 32 may be provided with a value of 1.5 μF/900V, and capacitor 74 may comprise 27 capacitors (27×) each having a value of 10 μF/50V in parallel. In such an exemplary implementation or embodiment, switches 42, 54, and 56 at the HV side may each comprise a Silicon Carbide (SiC) metal-oxide semiconductor field-effect transistor (MOSFET) 750V, although it is noted that other technologies are possible depending on the maximum voltage on the HV side. Switches 66, 68, 70, and 72 on the LV side may each comprise (2×) 80V/1.4 mΩ MOSFETs. As well, diode 44 may comprise a 1200V/10 A SiC Schottky Diode, and diode 48 may comprise a 1000V UFastDiode. Each of the capacitors C_{3P1} and C_{4P1} at the HV side may be provided with a value of 5.6 μF/500V, and the remaining transistor at the LV side connected to EMI filter 76 may comprise (2×) 40V/0.4 mΩ MOSFETs.

As those skilled in the art will understand, the controllers 90, 100, as well as any other component, system, subsystem, unit, circuit, stage, module, interface, sensor, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof, any component, system, subsystem, unit, circuit, stage, module, interface, sensor, device, or the like described herein, and/or for performing the particular algorithm or algorithms represented by the various methods, functions and/or operations described herein, including interaction between and/or cooperation with each other.

As described herein, the present disclosure thus provides a solution to the malfunction described previously involving a DC-to-DC converter wherein the voltage of a HV battery falls below a threshold value insufficient for proper operation of the DC-to-DC converter, without incurring any efficiency penalty for the DC-to-DC converter to prevent a very seldom-occurring failure. The present disclosure also provides such a solution with fewer components, thereby reducing weight and size of a DC-to-DC converter, and is easily scalable in different power and vehicle architecture environments. The solution of the present disclosure is also adaptable for use in a 12 volt battery-less electric vehicle architecture while covering HV battery failure use cases.

Item 1: In one embodiment, the present disclosure provides a voltage converter comprising a converter stage comprising a direct current to direct current (DC-to-DC) voltage converter, wherein the converter stage receives a first DC voltage and outputs a second DC voltage different than the first DC voltage, and a boost pre-stage comprising a boosting circuit and a capacitor, wherein the boost pre-stage receives a DC voltage from a battery and outputs a boosted DC voltage to the converter stage as the first DC voltage, wherein the boosted DC voltage is greater than the DC voltage from the battery. The boosted DC voltage of the boost pre-stage output to the converter stage provides fault resistant operation of the converter stage in the event of one or more fluctuations in an operating range of the DC voltage from the battery.

Item 2: In another embodiment, the present disclosure provides the voltage converter according to Item 1, wherein the boosting circuit comprise an inductor, a diode, and a switch, and wherein an output of the boosting circuit charges the capacitor and provides electrical power to the DC-to-DC converter.

Item 3: In another embodiment, the present disclosure provides the voltage converter according to Item 2, wherein discharge of the capacitor provides electrical power to the DC-to-DC converter.

Item 4: In another embodiment, the present disclosure provides the voltage converter according to Item 2 or Item 3, further comprising a controller that controls operation of the switch to effect charging of the capacitor.

Item 5: In another embodiment, the present disclosure provides the voltage converter according to any of the preceding Items, further comprising a DC link capacitor connected in parallel with the DC-to-DC converter of the converter stage.

Item 6: In another embodiment, the present disclosure provides the voltage converter according to any of the preceding Items, wherein the first DC voltage is greater than the second DC voltage.

Item 7: In another embodiment, the present disclosure provides the voltage converter according to any of the preceding Items, wherein the first DC voltage is equal to or greater than 400 volts and the second DC voltage is equal to or less than 12 volts.

Item 8: In another embodiment, the present disclosure provides the voltage converter according to any of the preceding Items, wherein the DC-to-DC converter of the converter stage supplies electrical power from a high voltage battery to electrical loads on a low voltage network to power the electrical loads.

Item 9: In another embodiment, the present disclosure provides the voltage converter according to any of the preceding Items, wherein the DC-to-DC converter of the converter stage supplies electrical power from a high voltage battery to a low voltage battery to charge the low voltage battery.

Item 10: In another embodiment, the present disclosure provides a vehicle comprising the voltage converter according to any of the preceding Items.

Item 11: In another embodiment, the present disclosure provides a non-transitory computer readable storage medium having stored computer executable instructions for controlling a voltage converter comprising (i) a converter stage comprising a direct current to direct current (DC-to-DC) voltage converter and (ii) a boost pre-stage comprising a boosting circuit and a capacitor. Execution of the computer executable instructions causes the voltage converter to, in response to receipt of a DC voltage from a battery, output a boosted DC voltage to the converter stage, wherein the boosted DC voltage is greater than the DC voltage from the battery, and receive the boosted DC voltage at the converter stage as a first DC voltage and output from the converter stage a second DC voltage, wherein the second DC voltage is different than the first DC voltage. The boosted DC voltage of the boost pre-stage output to the converter stage provides fault resistant continued operation of the converter stage in the event of one or more fluctuations in an operating range of the DC voltage from the battery.

Item 12: In another embodiment, the present disclosure provides the non-transitory computer readable storage medium according to Item 11, wherein the boosting circuit comprise an inductor and a switch, and wherein an output of the boosting circuit charges the capacitor and provides electrical power to the DC-to-DC converter.

Item 13: In another embodiment, the present disclosure provides the non-transitory computer readable storage medium according to Item 12, wherein discharge of the capacitor provides electrical power to the DC-to-DC converter.

Item 14: In another embodiment, the present disclosure provides the non-transitory computer readable storage medium according to Item 12 or 13, wherein the voltage converter further comprises a controller, and wherein execution of the computer executable instructions causes the controller to operate the switch to effect charging of the capacitor.

Item 15: In another embodiment, the present disclosure provides the non-transitory computer readable storage medium according to any of the preceding Items, wherein the voltage converter further comprises a DC link capacitor connected in parallel with the DC-to-DC converter of the converter stage.

Item 16: In another embodiment, the present disclosure provides the non-transitory computer readable storage medium according to any of the preceding Items, wherein the first DC voltage is greater than the second DC voltage.

Item 17: In another embodiment, the present disclosure provides the non-transitory computer readable storage medium according to any of the preceding Items, wherein the first DC voltage is greater than or equal to 400 volts and the second DC voltage is less than or equal to 12 volts.

Item 18: In another embodiment, the present disclosure provides the non-transitory computer readable storage medium according to any of the preceding Items, wherein the DC-to-DC converter of the converter stage supplies electrical power from a high voltage battery to electrical loads on a low voltage network to power the electrical loads.

Item 19: In another embodiment, the present disclosure provides the non-transitory computer readable storage medium according to any of the preceding Items, wherein the DC-to-DC converter of the converter stage supplies electrical power from a high voltage battery to a low voltage battery to charge the low voltage battery.

Item 20: In another embodiment, the present disclosure provides a vehicle comprising the non-transitory computer readable storage medium according to any of the preceding Items.

While exemplary embodiments are described above, it is not intended that these embodiments describe all possible forms according to the disclosure. In that regard, the words used in the specification are words of description rather than limitation, and it is understood that various changes may be made without departing from the spirit and scope of the disclosure. Additionally, unless the context clearly indicates otherwise, the various features, elements, components, methods, procedures, steps, and/or functions of various implementing embodiments may be combined or utilized in any combination or combinations and/or may be performed in any order other than those specifically described herein to form further embodiments according to the present disclosure.

1. A voltage converter comprising:
a converter stage comprising a direct current to direct current (DC-to-DC) voltage converter, wherein the converter stage receives a first DC voltage and outputs a second DC voltage different than the first DC voltage;
a boost pre-stage comprising a boosting circuit and a capacitor, wherein the boost pre-stage receives a DC voltage from a battery and outputs a boosted DC voltage to the converter stage as the first DC voltage, wherein the boosted DC voltage is greater than the DC voltage from the battery;
wherein the boosted DC voltage of the boost pre-stage output to the converter stage provides fault resistant operation of the converter stage in the event of one or more fluctuations in an operating range of the DC voltage from the battery.

2. The converter according to claim 1, wherein the boosting circuit comprise an inductor, a diode, and a switch, and wherein an output of the boosting circuit charges the capacitor and provides electrical power to the DC-to-DC converter.

3. The converter according to claim 2, wherein discharge of the capacitor provides electrical power to the DC-to-DC converter.

4. The converter according to claim 2, further comprising a controller that controls operation of the switch to effect charging of the capacitor.

5. The converter according to claim 1, further comprising a DC link capacitor connected in parallel with the DC-to-DC converter of the converter stage.

6. The converter according to claim 1, wherein the first DC voltage is greater than the second DC voltage.

7. The converter according to claim 1, wherein the first DC voltage is equal to or greater than 400 volts and the second DC voltage is equal to or less than 12 volts.

8. The converter according to claim 1, wherein the DC-to-DC converter of the converter stage supplies electrical power from a high voltage battery to electrical loads on a low voltage network to power the electrical loads.

9. The converter according to claim 1, wherein the DC-to-DC converter of the converter stage supplies electrical power from a high voltage battery to a low voltage battery to charge the low voltage battery.

10. A vehicle comprising the converter according to claim 1.

11. A non-transitory computer readable storage medium having stored computer executable instructions for controlling a voltage converter comprising (i) a converter stage comprising a direct current to direct current (DC-to-DC) voltage converter and (ii) a boost pre-stage comprising a boosting circuit and a capacitor, wherein execution of the computer executable instructions causes the converter to:
in response to receipt of a DC voltage from a battery, output a boosted DC voltage to the converter stage, wherein the boosted DC voltage is greater than the DC voltage from the battery; and
receive the boosted DC voltage at the converter stage as a first DC voltage and output from the converter stage a second DC voltage, wherein the second DC voltage is different than the first DC voltage;
wherein the boosted DC voltage of the boost pre-stage output to the converter stage provides fault resistant continued operation of the converter stage in the event of one or more fluctuations in an operating range of the DC voltage from the battery.

12. The non-transitory computer readable medium according to claim 11, wherein the boosting circuit comprise an inductor and a switch, and wherein an output of the boosting circuit charges the capacitor and provides electrical power to the DC-to-DC converter.

13. The non-transitory computer readable medium according to claim 12, wherein discharge of the capacitor provides electrical power to the DC-to-DC converter.

14. The non-transitory computer readable medium according to claim 12, wherein the converter further comprises a controller, and wherein execution of the computer executable instructions causes the controller to operate the switch to effect charging of the capacitor.

15. The non-transitory computer readable medium according to claim 11, wherein the converter further comprises a DC link capacitor connected in parallel with the DC-to-DC converter of the converter stage.

16. The non-transitory computer readable medium according to claim 11, wherein the first DC voltage is greater than the second DC voltage.

17. The non-transitory computer readable medium according to claim 11, wherein the first DC voltage is greater than or equal to 400 volts and the second DC voltage is less than or equal to 12 volts.

18. The non-transitory computer readable medium according to claim 11, wherein the DC-to-DC converter of the converter stage supplies electrical power from a high voltage battery to electrical loads on a low voltage network to power the electrical loads.

19. The non-transitory computer readable medium according to claim 11, wherein the DC-to-DC converter of the converter stage supplies electrical power from a high voltage battery to a low voltage battery to charge the low voltage battery.

20. A vehicle comprising the non-transitory computer readable medium according to claim 11.
